(19) United States
(12) Patent Application Publication
(10) Pub. No.: US 2013/0189167 A1
(43) Pub. Date: Jul. 25, 2013

(54) Micro Buret

(71) Applicant: Don Kosterman, Paris, TX (US)

(72) Inventor: Don Kosterman, Paris, TX (US)

(21) Appl. No.: 13/354,190

(22) Filed: Jan. 19, 2012

(51) Int. Cl. B01L 3/02

(52) U.S. Cl. 422/523

(57) ABSTRACT

A gravity flow device for dispensing a fluid may include a gravity flow body to retain the fluid, a valve body to control the flow of the fluid, and a detachable stem to connect to the valve body. The gravity flow device may be formed from glass, and the detachable stem may be formed from plastic. The gravity flow device may be a burette, and the removable stem may decrease in diameter. The gravity flow body may include a central passageway, and the valve body may include a central passageway to cooperate with the central passageway of the gravity flow body. The detachable stem may include a central passageway to cooperate with the central passageway of the valve body.

### FIELD OF THE INVENTION

The present invention relates to gravity feed devices and more particularly to a burette having a high rate of dispensing fluid.

### BACKGROUND

A burette (also buret) is a vertical cylindrical piece of laboratory glassware with a volumetric graduation on its full length and a precision tap, or stopcock, on the bottom. It is used to dispense known amounts of a liquid reagent in experiments for which such precision is necessary, such as a titration experiment. Burettes are extremely accurate—a 50 cm³ burette has a tolerance of 0.1 cm³ (class B) or 0.06 cm³ (class A).

Burettes measure from the top since they are used to measure liquids dispensed out the bottom. The difference between starting and final volume is the amount dispensed

Typically, the burette maybe formed from glass in order to provide a inert material to prevent interaction with the liquid fluid which may be stored within the burette. The tip of the burette is formed from glass. However the glass tip tends to retard the flow of liquid fluid from the burette. What is desired is a tip that will increase the speed and consequently the amount of fluid that can flow from the burette.

### SUMMARY

A gravity flow device for dispensing a fluid may include a gravity flow body to retain the fluid, a valve body to control the flow of the fluid, and
a detachable stem to connect to the valve body.

The gravity flow device may be formed from glass, and the detachable stem may be formed from plastic.

The gravity flow device may be a burette, and the removable stem may decrease in diameter.

The gravity flow body may include a central passageway, and the valve body may include a central passageway to cooperate with the central passageway of the gravity flow body.

The detachable stem may include a central passageway to cooperate with the central passageway of the valve body.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the gravity flow device of the present invention;

FIG. 2 illustrates a bottom view of the gravity flow device of the present invention;

FIG. 3 illustrates a perspective view of a portion of the gravity flow device of the present invention;

FIG. 4 illustrates a perspective view of the gravity flow device of the present invention;

FIG. 5 illustrates a perspective view of the removable stem (s) of the gravity flow device of the present invention.

### DETAILED DESCRIPTION

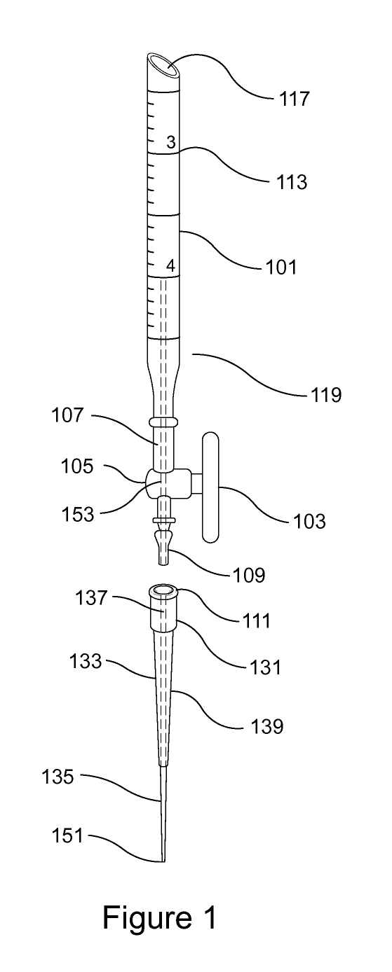

FIG. 1 illustrates a side view of the gravity flow device 100 which may be a burette and which may include a gravity flow body 101 which may be a hollow cylinder. The gravity flow body 100 includes a central passageway 117 which may contain a fluid which may be a liquid fluid in order to be precisely dispensed from the burette. The gravity flow body 101 may include a truncated cone shaped outlet in order to connect with a friction fit to the valve body 105 which may be a stop cock. The valve body 105 may be controlled by a rotatable handle 103 which may restrict the flow of the liquid fluid or completely block the flow of the liquid fluid from the gravity flow body 101. The valve body 105 may include an inlet 107 to connect to the outlet of the gravity flow body 101. The valve body 105 may include a valve outlet 109 to allow the liquid fluid to flow from the valve body 105 to the removable stem 111 which may be formed from plastic or other suitable material in order to increase the flow of the liquid fluid from the valve outlet 109. The valve body 105 may include a central aperture 153 which may extend through the valve body 105 to cooperate with the central passageway 117 of the gravity flow body 101 and the first central passageway 137 of the removable stem 111. The valve body 105 may be removable from the outlet of the gravity flow body 101 and replaceable. The valve outlet 109 may include a portion which may be a truncated cone shaped in order to provide a friction fit with the removable stem/tip 111. The removable stem may include a first portion 131 which may be cylindrical and include a central passageway 137 and may be a larger diameter than the second portion 133 which may be cylindrical and include a second central passageway 139 to cooperate with the first central passageway 137. The second portion 133 may be of larger diameter than the third portion 135 which may be cylindrical which may include a third central passageway 151 to cooperate with the second central passageway 139. FIG. 1 illustrates indicia 113 which may be used to measure the fluid within the passageway 117.

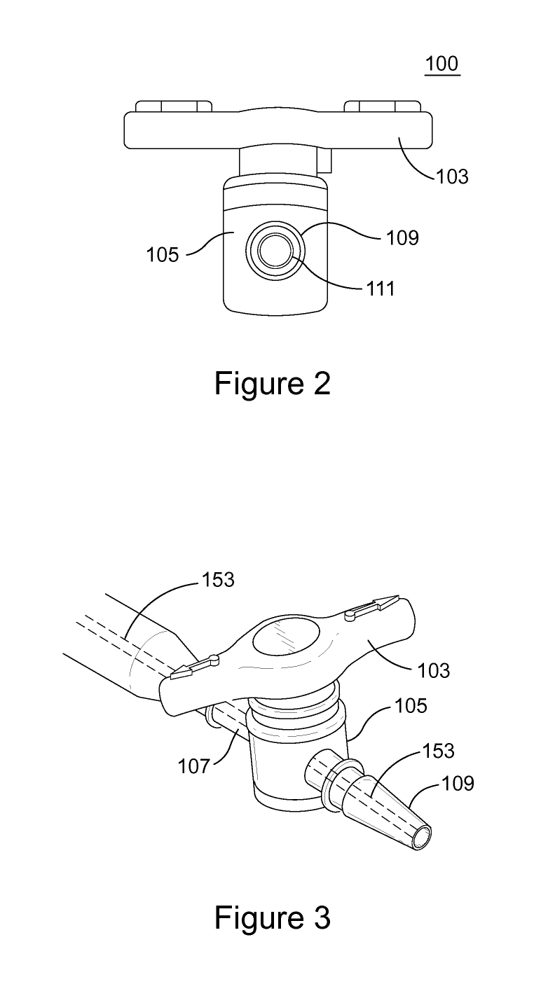

FIG. 2 illustrates an end view of the valve body 105 and the valve handle 103 which may control the flow of liquid fluid through the valve body 105. FIG. 2 additionally illustrates the removable stem 111 and the valve outlet 109.

FIG. 3 illustrates a perspective view of the valve body 105 which may be connected to a valve handle 103 to restrict the flow of fluid through the valve body 105. The valve body 105 may also include a valve inlet 107 and a valve outlet 109 which may include a portion which may be shaped as a truncated cone. FIG. 3 illustrates a central aperture 153 which may extend through the valve body 105.

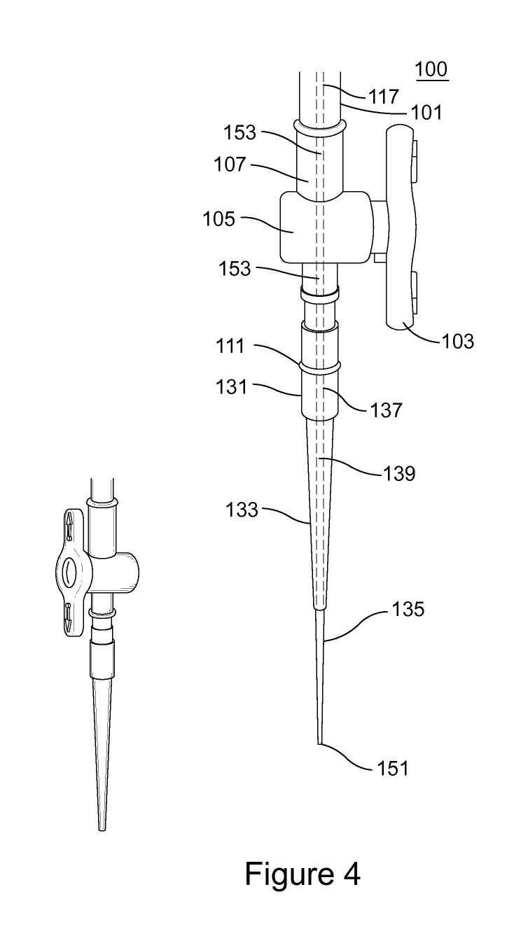

FIG. 4 illustrates a perspective view of the gravity flow device 100 which may be a burette and which may include a gravity flow body 101 which may be a hollow cylinder. The gravity flow body 100 includes a central passageway 117 which may contain a fluid which may be a liquid fluid in order to be precisely dispensed from the burette. The gravity flow body 101 may include a truncated cone shaped outlet in order to connect to the valve body 105 which may be a stop cock. The valve body 105 may be controlled by a rotatable handle 103 which may restrict the flow of the liquid fluid or completely block the flow of the liquid fluid from the gravity flow body 101. The valve body 105 may include an inlet 107 to connect to the outlet of the gravity flow body 101. The valve body 105 may include a valve outlet 109 to allow the liquid fluid to flow from the valve body 105 to the removable stem 111 which may be formed from plastic in order to increase the flow of the liquid fluid from the valve outlet 109. The valve body 105 may include a central aperture 153 which may extend through the valve body 105 to cooperate with the central passageway 117 of the gravity flow body 101 and the first central passageway 137 of the removable stem 111. The valve body 105 may be removable from the outlet of the gravity flow body 101 and replaceable. The valve outlet 109 may include a portion which may be a truncated cone shaped in order to provide a friction fit with the removable stem/tip 111. The removable stem may include a first portion 131 which may be cylindrical and include a central passageway 137 and may be a larger diameter than the second portion 133 which may be cylindrical and include a second central passageway 139 to cooperate with the first central passageway 137. The second portion 133 may be of larger diameter than the third portion 135 which may be cylindrical which may include a third central passageway 151 to cooperate with the second central passageway 139.

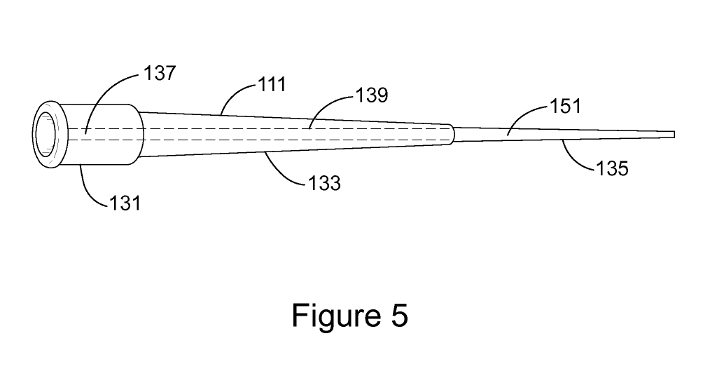

The removable stems are illustrated in FIG. 5 and may include a first portion 131 which may be cylindrical and include a central passageway 137 and may be a larger diameter than the second portion 133 which may be cylindrical and include a second central passageway 139 to cooperate with the first central passageway 137. The second portion 133 may be of larger diameter than the third portion 135 which may be cylindrical which may include a third central passageway 151 to cooperate with the second central passageway 139. The removable stem may include a substantially tapered shape, a substantially constant diameter cylinder shape or other appropriate shapes.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A gravity flow device for dispensing a fluid, comprising:
a gravity flow body to retain the fluid,
a valve body to control the flow of the fluid,
a detachable stem to connect to the valve body,
wherein the gravity flow device is formed from glass and the detachable stem is formed from plastic.

2) A gravity flow device for dispensing a fluid as in claim 1, wherein the gravity flow device is a burette.

3) A gravity flow device for dispensing a fluid as in claim 1, wherein the removable stem decreases in diameter.

4) A gravity flow device for dispensing a fluid as in claim 1, wherein the gravity flow body includes a central passageway.

5) A gravity flow device for dispensing a fluid as in claim 4, wherein the valve body includes a central passageway to cooperate with the central passageway of the gravity flow body.

6) A gravity flow device for dispensing a fluid as in claim 5, wherein the detachable stem includes a central passageway to cooperate with the central passageway of the valve body.
